(19) United States
(12) Patent Application Publication
(10) Pub. No.: US 2026/0178640 A1
(43) Pub. Date: Jun. 25, 2026

(54) ELECTRONIC DEVICE FOR PROVIDING CONTENT SEARCH FOR SENTENCE-LIKE UTTERANCES AND OPERATING METHOD THEREOF

(71) Applicant: SAMSUNG ELECTRONICS CO., LTD., Suwon-si (KR)

(72) Inventors: Sunghoon JO, Suwon-si (KR); Chanho PARK, Suwon-si (KR); Mingyu LEE, Suwon-si (KR); Jongil CHOI, Suwon-si (KR)

(73) Assignee: SAMSUNG ELECTRONICS CO., LTD., Suwon-si (KR)

(21) Appl. No.: 19/273,457

(22) Filed: Jul. 18, 2025

Related U.S. Application Data
(63) Continuation of application No. PCT/KR2025/008771, filed on Jun. 24, 2025.

(30) Foreign Application Priority Data
Dec. 20, 2024 (KR) 10-2024-0193138

(51) Int. Cl. G06F 16/338; G06F 16/334; G10L 15/18

(52) U.S. Cl. CPC G06F 16/338; G06F 16/3347; G10L 15/1822

(57) ABSTRACT

An electronic device including a display; a microphone; and at least one processor configured to: receive a user voice input through the microphone, obtain a first query embedding based on the user voice input, obtain similarities between a plurality of metadata embedding vectors included in a metadata database and the first query embedding, obtain, among the plurality of metadata embedding vectors, one or more similar pieces of metadata having a similarity greater than or equal to a first threshold value based on the similarities, obtain an order of the one or more similar pieces of metadata based on the similarity or a weight for at least one metadata belong to a same content, and control the display to output, according to the order, information related to contents corresponding to the one or more similar pieces of metadata.

### CROSS-REFERENCE TO RELATED APPLICATION(S)

This application is a continuation of International Application No. PCT/KR2025/008771 designating the United States, filed on Jun. 24, 2025, in the Korean Intellectual Property Receiving Office, and claiming priority to Korean Patent Application No. 10-2024-0193138, filed on Dec. 20, 2024, in the Korean Intellectual Property Office, the disclosures of each of which are incorporated by reference herein in their entireties.

### TECHNICAL FIELD

Various embodiments of the disclosure relate to an electronic device for providing content search for sentence-like utterances and an operating method thereof.

### BACKGROUND ART

Digital content comes in many different types and is available on a variety of online platforms. For example, digital content is mainly produced and consumed in the form of movies, TV shows, sports, and user-generated videos. Online platforms, such as OTT platforms, SNS, and video platforms are being used by many people.

Technologies for searching digital content include keyword-based search and semantic-based search. Keyword-based search is fast and easy to implement, but has difficulty reflecting specific user intent. Semantic-based search is implemented using deep learning technology that utilizes natural language processing NLP and machine learning. For example, a transformer-based model may understand the context of the user's query sentence and search for retrieve highly relevant content.

The above-described information may be provided as related art for the purpose of helping understanding of the disclosure. No claim or determination is made as to whether any of the foregoing is applicable as background art in relation to the disclosure.

### DISCLOSURE OF INVENTION

### Solution to Problems

According to an embodiment of the disclosure, an electronic device may include: a display; a microphone; and at least one processor configured to: receive a user voice input through the microphone, obtain a first query embedding based on the user voice input, obtain similarities between a plurality of metadata embedding vectors included in a metadata database and the first query embedding, obtain, among the plurality of metadata embedding vectors, one or more similar pieces of metadata having a similarity greater than or equal to a first threshold value based on the similarities, obtain an order of the one or more similar pieces of metadata based on the similarity or a weight for at least one metadata belong to a same content, and control the display to output, according to the order, information related to contents corresponding to the one or more similar pieces of metadata.

According to an embodiment of the disclosure, at least one processor may be configured to: receive information corresponding to a first content from a server, and obtain the plurality of metadata embedding vectors, based on the information corresponding to the first content, for the first content.

According to an embodiment of the disclosure, information corresponding to the first content may include at least one of a title, a character, an actor, a writer, a director, a synopsis, a release date, a genre, or a main plot.

According to an embodiment of the disclosure, at least one processor may be configured to: obtain additional information corresponding to the first content using an artificial intelligence model, and obtain the plurality of metadata embedding vectors, based on the additional information corresponding to the first content, for the first content.

According to an embodiment of the disclosure, at least one processor may be configured to: generate a prompt corresponding to obtaining one or more pieces of category information corresponding to the first content, and obtain information through the artificial intelligence model, based on the prompt, as the additional information corresponding to the first content.

According to an embodiment of the disclosure, additional information may include at least one of a time period, a mood, a theme, a setting, a subject, a character profession, a prominent keyword, a cultural background, a story classification, a best for which generation, a film industry, an around relationship, a hidden meaning, a hidden message, a plot, a year of publication, a cast, a director, or a related video.

According to an embodiment of the disclosure, at least one processor may be configured to obtain the similarities between the plurality of metadata embedding vectors included in the metadata database and the first query embedding through a cosine similarity calculation method.

According to an embodiment of the disclosure, at least one processor may be configured to: assign weights to each of the similarities of pieces of metadata belong to the same content among the one or more pieces of similar metadata, obtain a final similarity for each content for the one or more similar pieces of metadata, and rearrange, according to the final similarity, the one or more similar pieces of metadata.

According to an embodiment of the disclosure, at least one processor may be configured to: control the display to output information related to the contents corresponding to the one or more similar pieces of metadata, including a description corresponding to a category of the metadata.

According to an embodiment of the disclosure, at least one processor may be configured to: based on the one or more similar pieces of metadata corresponding to a similarity less than the threshold, store the user voice input in a voice input database, and control the display to output information corresponding to a search failure.

According to an embodiment of the disclosure, a server may include: a communication circuit; memory; and at least one processor configured to: receive a user voice input for a content search request from a first electronic device through the communication circuit, obtain a first query embedding based on the user voice input, obtain similarities between a plurality of metadata embedding vectors included in a metadata database and the first query embedding, obtain, among the plurality of metadata embedding vectors, one or more similar pieces of metadata having a similarity greater than or equal to a first threshold value based on the similarities, obtain an order of the one or more similar pieces of metadata based on the similarity or a weight for at least one metadata belong to a same content, and transmit, through the communication circuit to the first electronic device, information related to contents corresponding to the one or more similar pieces of metadata, including the order information.

According to an embodiment of the disclosure, at least one processor may be configured to: receive information corresponding to a first content from an external server through the communication circuit, and store the plurality of metadata embedding vectors, based on the information corresponding to the first content, for the first content, in the metadata database.

According to an embodiment of the disclosure, a server may include information corresponding to the first content includes at least one of a title, a character, an actor, a writer, a director, a synopsis, a release date, a genre, or a main plot.

According to an embodiment of the disclosure, a server may include at least one processor configured to: obtain additional information corresponding to the first content using an artificial intelligence model, obtain the plurality of metadata embedding vectors, based on the additional information corresponding to the first content, for the first content, and store the plurality of metadata embedding vectors in the metadata database.

According to an embodiment of the disclosure, a server may include at least one processor configured to: generate a prompt corresponding to obtaining one or more pieces of category information corresponding to the first content, and obtain, through the artificial intelligence model, information based on the prompt as the additional information corresponding to the first content.

According to an embodiment of the disclosure, a server may include additional information that includes at least one of a time period, a mood, a theme, a setting, a subject, a character profession, a prominent keyword, a cultural background, a story classification, a best for which generation, a film industry, an around relationship, a hidden meaning, a hidden message, a plot, a year of publication, a cast, a director, or a related video.

According to an embodiment of the disclosure, a server may include at least one processor configured to obtain the similarities between the plurality of metadata embedding vectors included in the metadata database and the first query embedding through a cosine similarity calculation method.

According to an embodiment of the disclosure, a server may include at least one processor configured to: assign weights to each of the similarities of pieces of metadata belong to the same content among the one or more pieces of similar metadata, obtain a final similarity for each content for the one or more similar pieces of metadata, and rearrange, according to the final similarity, the one or more similar pieces of metadata.

According to an embodiment of the disclosure, a server may include at least one processor configured to: based on the one or more similar pieces of metadata corresponding to a similarity less than the threshold, store the user voice input in a voice input database, and transmits information corresponding to a search failure to the first electronic device through the communication circuit.

According to an embodiment of the disclosure, a non-transitory, computer-readable storage medium storing instructions may include instructions, when executed by one or more processors, enable the one or more processors to: receive a user voice input through a microphone of an electronic device, obtain a first query embedding based on the user voice input, obtain similarities between a plurality of metadata embedding vectors included in a metadata database and the first query embedding, obtain, among the plurality of metadata embedding vectors, one or more similar pieces of metadata having a similarity greater than or equal to a first threshold value based on the similarities, obtain an order of the one or more similar pieces of metadata based on the similarity or a weight for at least one metadata belong to a same content, and control a display of the electronic device to output, according to the order, information related to contents corresponding to the one or more similar pieces of metadata.

### BRIEF DESCRIPTION OF DRAWINGS

The same or similar reference denotations may be used to refer to the same or similar elements throughout the specification and the drawings.

FIG. 1 illustrates an example of a search screen according to an embodiment of the disclosure;

FIG. 2 is a block diagram illustrating components of an electronic device according to an embodiment of the disclosure;

FIG. 3 is a flowchart illustrating an operation by which an electronic device performs a content search for a user utterance according to an embodiment of the disclosure;

FIG. 4 is a block diagram illustrating a search function component of an electronic device according to an embodiment of the disclosure;

FIG. 5 is a flowchart illustrating an operation by which an electronic device stores metadata of content in a database according to an embodiment of the disclosure;

FIG. 6 is a flowchart illustrating an operation by which an electronic device stores additional metadata of content in a database according to an embodiment of the disclosure;

FIG. 7 is a block diagram illustrating a metadata generation function component of an electronic device according to an embodiment of the disclosure;

FIG. 8 illustrates an example of metadata according to an embodiment of the disclosure;

FIG. 9 illustrates an example of a search result table according to a user utterance of an electronic device according to an embodiment of the disclosure;

FIG. 10 illustrates an example of a search result screen of an electronic device according to an embodiment of the disclosure; and

FIG. 11 illustrates an electronic device, a database, and a cloud server according to an embodiment of the disclosure.

### MODE FOR THE INVENTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

Hereinafter, embodiments of the present disclosure are described in detail with reference to the accompanying drawings.

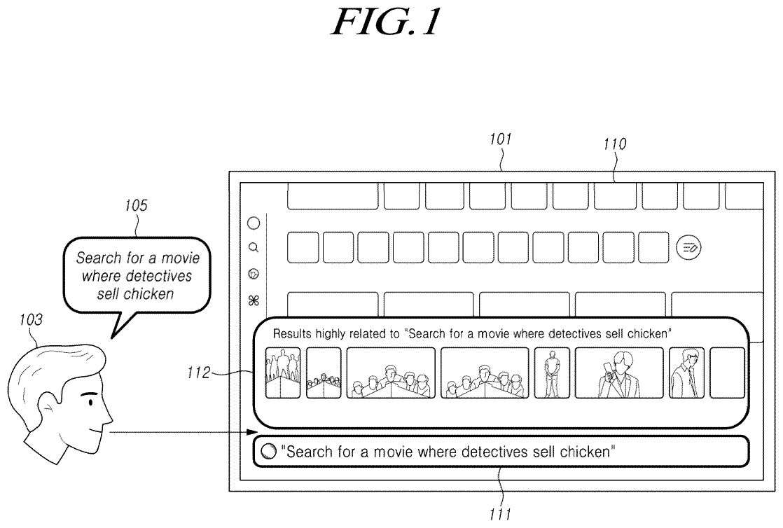

FIG. 1 illustrates an example of a search screen according to an embodiment of the disclosure.

According to an embodiment, the electronic device 101 may receive a user utterance 105 by the user 103 using an input device (e.g., a microphone), grasp the meaning of the user's utterance, and provide the result 112 of searching for content highly related to the meaning to the user 103 through an output device (e.g., a display).

According to an embodiment, the electronic device 101 may process sentence-like utterances including user intentions in addition to simple keywords. The sentence-like utterance includes a sentence for requesting a search and may include a description of the search target. Unlike keyword search requests that refer to specific information such as the title of the content, characters, actors, and directors, the description of the search target may indicate a description related to the content, such as the plot of the content, major scenes, period settings, and relationships between characters. Accordingly, the user utterance 105 may be a sentence-like utterance describing a specific scene or major synopsis, rather than origin information such as the title, character, and director of the movie. For example, referring to FIG. 1, the user utterance 105 may be “Search for a movie where detectives sell chicken!” which describes the major scenario.

According to an embodiment, the electronic device 101 may understand the user utterance 105 and search the content metadata DB for content matching the meaning of the user utterance 105. In order to compare the meanings of the user utterance 105 and the content metadata, the electronic device 101 may convert them into their respective embedding vectors and calculate a simultaneously between the vectors to determine the correlation. According to an embodiment, the electronic device 101 may convert text information (e.g., user utterance, content metadata) into an embedding vector using a text encoder. The text encoder may be implemented as a deep learning-based model that has been trained with the similarities of words and the contexts of sentences. The electronic device 101 may calculate a similarity value between the embedding vector for the user utterance and the embedding vector for the content metadata using the cosine similarity, and determine whether the content is highly related to the user utterance according to the value.

The electronic device 101 according to an embodiment may use metadata for content for semantic-based content search. The metadata for the content may include various pieces of information about the content. For example, as origin information about content, when the content is a movie, the title, character, actor, writer, director, release date (opening date), genre, synopsis, and main plot may be stored as the metadata for the content. The electronic device 101 may further obtain additional information in addition to the origin information about the content provided by the content provider and use it as metadata.

Unlike keyword search that matches keywords included in content information, it may provide content search that has higher accuracy in semantic-based content search for the user utterance, i.e., highly related to the user utterance (query), as the metadata information about the content increases. The electronic device 101 according to an embodiment may additionally add various pieces of information about the content as metadata using a large language model (LLM) in addition to the origin information provided by the content provider.

The electronic device 101 may obtain additional information through a search for various items describing the content. For example, the electronic device 101 may search for reviews of the content and store some of the reviews as metadata for the content. The electronic device 101 may use a large language model LLM to obtain additional information. For example, the electronic device 101 may ask the LLM questions about various item values for content and store content information generated by the LLM as metadata. One content may include a plurality of pieces of metadata. The electronic device 101 may convert content metadata into an embedding vector and store the same in a database and search for it. The electronic device 101 may obtain a search result according to the determination of similarity to the user utterance based on the content metadata, and one or more pieces of metadata for the same content may be included in the search results. The electronic device 101 may rearrange the search results based on the content and provide top-linked contents to the user.

The electronic device 101 according to an embodiment may receive the sentence-like utterance 105 of the user 103 and output a result of searching for content having a high correlation with the sentence-like utterance 105 on the display screen 110. The display screen 110 may include a first portion 111 for displaying text recognizing the sentence-like utterance 105 and a second portion 112 for displaying content lists corresponding to the search results.

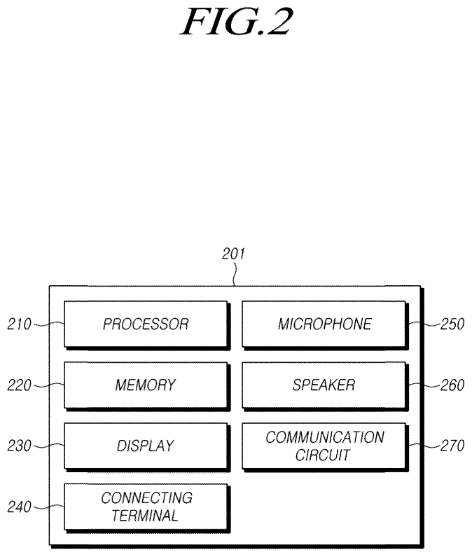

FIG. 2 is a block diagram illustrating components of an electronic device according to an embodiment of the disclosure.

An electronic device 201 (e.g., the electronic device 101 of FIG. 1) according to an embodiment may include a processor 210, a memory 220, a display 230, a connecting terminal 240, a microphone 250, a speaker 260, and a communication circuit 270. According to an example, the electronic device 201 may include additional components (e.g., a camera) other than the illustrated components, or may omit at least one of the illustrated components.

The processor 210 may execute, for example, software (e.g., a program) to control at least one other component (e.g., a hardware or software component) of the electronic device 201 coupled with the processor 220, and may perform various data processing or computation. According to an embodiment, as at least part of the data processing or computation, the processor 210 may store a command or data received from another component (e.g., the microphone 250) onto a volatile memory, process the command or the data stored in the volatile memory, and store resulting data in a non-volatile memory. According to an embodiment, the processor 210 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 201 includes the main processor and the auxiliary processor, the auxiliary processor may be configured to use lower power than the main processor or to be specified for a designated function. The auxiliary processor may be implemented separately from, or as part of, the main processor. According to an embodiment, the auxiliary processor (e.g., the neural processing unit) may include a hardware structure specified for artificial intelligence model processing. The artificial intelligence model may be generated via machine learning. Such learning may be performed, e.g., by the electronic device 201 where the artificial intelligence is performed or via a separate server (e.g., a cloud server). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 220 may store various data used by at least one component (e.g., the processor 210 or the display 230) of the electronic device 201. The data may include, e.g., input data or output data for software (e.g., a program) and related commands. The memory 230 may include a volatile memory or a non-volatile memory. The memory 220 may include a database in a volatile memory. In an embodiment, the memory 220 may include at least a portion of a content metadata database or a user utterance database.

The display 230 may visually provide information to the outside (e.g., the user) of the electronic device 201. The display 230 may include, e.g., a display panel, a hologram device, or a projector and a control circuit for controlling the device. According to an embodiment, the display panel may include a touch sensor configured to detect a touch, or a pressure sensor configured to measure the intensity of a force generated by the touch.

A connecting terminal 140 may include a connector via which the electronic device 201 may be physically connected with the external electronic device (e.g., a separate display device or an audio output device). According to an embodiment, the connecting terminal 140 may include, for example, a high-definition multimedia interface (HDMI) connector, a display port (DP), Thunderbolt, a USB connector, a SD card connector, or an audio connector (e.g., a headphone connector). The electronic device 201 may be connected to one or more external devices using the connecting terminal 140. The electronic device 201 may receive or transmit at least a portion of a video signal or an audio signal through the connecting terminal 140. The electronic device 201 may transmit search results according to a user utterance to an external display device connected through the connecting terminal 140 and output them through the external display device.

The microphone 250 is an input device sensor that detects sound and may provide a voice recognition function. The electronic device 201 may recognize the user's voice through the microphone 250 and receive a user utterance requesting a content search.

The speaker 260 is an audio output device that allows the user to hear sound along with the video. The speaker 260 may include a speaker driver, an amplifier, and a sound processor. The sound processor may store and manage a sound output table of the speaker 260. The electronic device 201 may output information about content search results through the speaker 260.

The communication circuit 270 may support establishing a direct (e.g., wired) communication channel or a wireless communication channel between the electronic device 201 and the external electronic device (e.g., a remote control, an audio output device, a source device, or a content providing server) and performing communication via the established communication channel. The communication circuit 270 may include one or more communication processors that are operable independently from the processor 210 (e.g., the application processor (AP)) and supports a direct (e.g., wired) communication or a wireless communication. According to an embodiment, the communication circuit 270 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the remote control or content providing server via a first network (e.g., a short-range communication network, such as Bluetooth™, wireless-fidelity (Wi-Fi) direct, or infrared data association (IrDA)) or a second network (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module may identify or authenticate the electronic device 101 in a communication network, such as the first network or the second network, using subscriber information (e.g., international mobile subscriber identity (IMSI)) stored in the subscriber identification module. The electronic device 201 may be connected to one or more contents servers, external storage devices or cloud servers via the communication circuit 270. The electronic device 201 may request and receive content information or content from the contents server. The electronic device 201 may request and receive content metadata information stored in the external storage device. The electronic device 201 may perform a semantic-based content search for a user utterance through the cloud server.

An electronic device 201 according to an embodiment may comprise a display 230, a microphone 250, and at least one processor 210. The at least one processor 210 may, when receiving a user voice input through the microphone, obtain similarities between a plurality of metadata embedding vectors included in a metadata database and a first query embedding obtained based on the user voice input, obtain one or more similar pieces of metadata corresponding to a similarity of a first threshold or more among the plurality of metadata embedding vectors, and control the display to output information related to contents corresponding to the one or more similar pieces of metadata according to an order based on at least one of the similarity or a weight for other metadata of the same content.

According to an embodiment, the at least one processor may receive information corresponding to first content from a server, and obtain an embedding vector obtained based on the information corresponding to the first content as metadata for the first content.

According to an embodiment, the information corresponding to the first content may include at least one of a title, a character, an actor, a writer, a director, a synopsis, a release date, a genre, or a main plot.

According to an embodiment, the at least one processor may obtain additional information corresponding to the first content through an artificial intelligence model, and obtain an embedding vector obtained based on the additional information as the metadata corresponding to the first content.

According to an embodiment, the at least one processor may generate a prompt corresponding to obtaining one or more pieces of category information corresponding to the first content, and obtain information obtained through the artificial intelligence model based on the prompt as the additional information corresponding to the first content.

According to an embodiment, the additional information may include at least one of a time period, an mood, a theme, a setting, a subject, a character profession, a prominent keyword, a cultural background, a story classification, best for which generation, a film industry, an around relationship, a hidden meaning, a hidden message, a plot, a year of publication, a cast, a director, or a related video.

According to an embodiment, the at least one processor may obtain the similarities between the plurality of metadata embedding vectors included in the metadata database and the first query embedding through a cosine similarity calculation method.

According to an embodiment, the at least one processor may assign a weight to each of similarity values of pieces of metadata corresponding to the same content for the one or more pieces of similar metadata, obtain a final similarity for each content for the one or more pieces of similar metadata, and rearrange the one or more pieces of similar metadata according to the obtained final similarity.

According to an embodiment, the at least one processor may control the display to output information related to contents corresponding to the one or more pieces of similar metadata, including a description corresponding to a category of the metadata.

According to an embodiment, the at least one processor may, when metadata having the similarity of the first threshold or more among the plurality of metadata embedding vectors is not obtained, store the user voice input in a voice input database, and control the display to output information corresponding to a search failure.

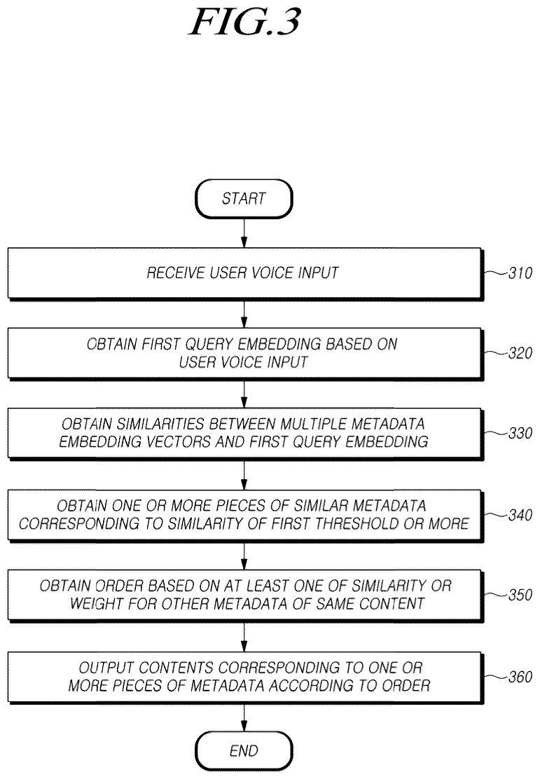

FIG. 3 is a flowchart illustrating an operation by which an electronic device performs a content search for a user utterance according to an embodiment of the disclosure.

The electronic device (e.g., the electronic device 101 of FIG. 1 and the electronic device 201 of FIG. 2) according to an embodiment may receive a user utterance for content search and compare metadata for the content with the user utterance, thereby searching for the content to be searched in the user utterance. In the following embodiment, each operation may be sequentially performed, but is not necessarily performed sequentially. For example, the order of the operations may be changed, and at least two operations may be performed in parallel.

In operation 310, the electronic device 101 according to an embodiment may receive a user voice input in response to a search input request through a microphone (e.g., the microphone 250 of FIG. 2). The user voice input may be a sentence-like utterance requesting a content search. According to an embodiment, when the user voice input is a sentence-like utterance, the electronic device 101 may perform a semantic-based content search on the metadata database. When receiving the sentence-like utterance, the electronic device 101 may perform operation 320.

According to an embodiment, when the user voice input is a keyword (a word) or a brief sentence including the keyword, the electronic device 101 may perform a keyword search in the content database instead of operation 320. The content database includes origin information about the content, and may be stored and managed in the structure of items and item values. For example, the content database may include data in a text format, such as (title, Extreme Job), (starring, Ryu Seung-ryong), and (director, Lee Byung-heon) for the first content.

In operation 320, the electronic device 101 according to an embodiment may obtain a first query embedding based on the user voice input. The electronic device 101 may obtain the first query embedding using a text encoder. The electronic device 101 may convert the user voice input into an embedding vector for comparison of similarity to metadata for content in the form of an embedding vector.

In operation 330, the electronic device 101 according to an embodiment may calculate the similarities between the embedding vectors of the metadata database DB and the first query embedding. The electronic device 101 may calculate, e.g., a cosine similarity value between each metadata embedding vector and the first query embedding. The electronic device 101 may determine that the similarity between the two vectors increases as the cosine similarity value approaches 1.

Alternatively, in an embodiment, the electronic device 201 may use various similarity determination methods. For example, the similarity determination method may be Euclidean distance, Manhattan distance, jaccard similarity, Pearson correlation coefficient, Mahalanobis distance, Hellinger distance, or Kullback-Liebler (KL) divergence.

In operation 340, the electronic device 101 according to an embodiment may obtain one or more pieces of similar metadata corresponding to a similarity larger than or equal to a threshold. The degree of similarity between the two vectors may be proportional to the association between the metadata of the content and the user voice input. The electronic device 101 may set a threshold corresponding to a level at which accuracy of the search result is expected. The electronic device 101 may modify the threshold by reflecting user feedback on the search result.

In operation 350, the electronic device 101 according to an embodiment may obtain an order based on at least one of the similarity or the weight for the other metadata of the same content. The electronic device 101 may rearrange the extracted metadata, i.e., embedding vectors of the metadata. The electronic device 101 may rearrange the extracted embedding vectors based on the content. The electronic device 101 may arrange the embedding vectors according to the content based on the similarity values, and leave only the metadata with the highest similarity value for the same content. The electronic device 101 may rearrange the metadata by reflecting the weight for the other metadata of the same content. When the plurality of pieces of metadata for the same content are extracted, the electronic device 101 may assign a weight to each of the metadata and adjust the rank of the corresponding content according to the sum of the weights. The electronic device 101 may rearrange the extracted embedding vectors considering both the similarity and the weight for the other metadata of the same content. The electronic device 101 may rearrange the metadata list considering the rank of metadata assigned the weight for the same content for the embedding vectors arranged according to the similarity.

In operation 360, the electronic device 101 according to an embodiment may output content corresponding to one or more pieces of similar metadata in the rearranged order. The electronic device 101 may output content corresponding to a top-linked embedding vector among the rearranged embedding vectors as a search result. The electronic device 101 may output both origin information about the content and metadata information corresponding to the embedding vector. Referring to FIG. 1, in response to “Search for a movie where detectives sell chicken,” the electronic device 101 may display configuration information indicating that in the movie Extreme Job, the detectives run a chicken restaurant for their undercover operation as metadata for the major setting for the movie while displaying the movie Extreme Job on the search result screen. Referring to FIG. 1, the electronic device 101 may display the setting information that detectives operate a chicken restaurant for latent work in an extreme job movie as metadata for the main setting for the extreme job movie while displaying the extreme job movie on the search result screen in response to “Find a movie where detectives sell chicken.”

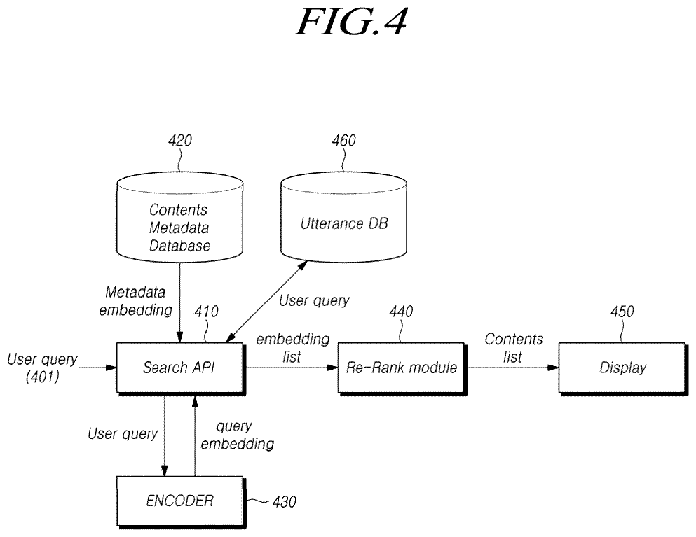

FIG. 4 is a block diagram illustrating a search function component of an electronic device according to an embodiment of the disclosure.

According to an embodiment, the electronic device (e.g., the electronic device 101 of FIG. 1 and the electronic device 201 of FIG. 2) may receive a user query (e.g., a sentence-like utterance) 401, search for content meant by the user query, output a search result through the display 450 and provide it to the user. The electronic device 101 may include a search API 410, a contents metadata database (DB), an encoder 430, a re-rank module 440, and a display 450 as components related to the search function. According to an example, the electronic device 101 may include additional components (e.g., a microphone) other than the illustrated components, or may omit at least one of the illustrated components. The omitted components may be provided by an external electronic device, and the electronic device 101 may transmit/receive necessary data through data communication with the external electronic device.

According to an embodiment, the search API 410 of the electronic device 101 may perform a content search for the user query. The search API 410 may calculate a similarity between the user query and the content metadata. The search API 410 may transfer the user query 401 to the encoder 430, and receive a query embedding vector embedding the user query 401 from the encoder 430. The search API 410 may receive a metadata embedding vector from the contents metadata database (DB) 420. The contents metadata DB 420 may store one or more pieces of metadata for the content in the form of an embedding vector.

The search API 410 may calculate a cosine similarity value between the query embedding and the metadata embedding vector, and generate an embedding list obtained by extracting embedding vectors larger than or equal to a threshold. When there is no embedding vector larger than or equal to the threshold, the search API 410 may store the user query 401 in the user utterance DB 460. The user utterance DB 460 may store user queries for which search failed. When the user query stored in the user utterance DB 460 is associated with a specific content by a user input, the user query for the corresponding content may be stored as metadata.

The re-rank module 440 may receive the embedding list extracted from the search API 410 and rearrange the embedding vectors considering at least a portion of the similarity and weights for other metadata of the same content. The embedding list may include embedding vectors arranged in descending order based on the similarity values.

When the plurality of pieces of metadata of the same content are included in the embedding list, the re-rank module 440 may give additional points to the corresponding content. For example, the re-rank module 440 may determine the similarity of the corresponding content based on the weighted sum of the respective similarity values of the metadata. Unlike similarity values calculated for each content metadata, the re-rank module 440 may increase the accuracy or quality of semantic-based search results by calculating a final similarity reflecting similarity values of several pieces of metadata for each content.

The re-rank module 440 may perform a re-rank in the following manner. It is assumed that there are a total of N embedding vectors having a similarity value between the user query embedding vector value and the embedding vector value of each metadata equal to or larger than a threshold. The metadata may include the same content, so that there may be the plurality of content identifiers (id). Up to M pieces of duplicate metadata may be included. In this case, the optimal value may be experimentally determined considering the accuracy of the search result and processing speed as the number M of pieces of metadata allowed to overlap for the same content.

The weight for metadata of the same content is referred to as W, and a default value of W may be set to 0.1. The similarity score (also referred to as a score range) may have a value between 0 and 1. A similarity value of 0 may mean no match at all. A similarity value of 1 may mean an exact match. It may be determined that as the similarity value approaches 1, they may be more similar to each other. The threshold for determining the similarity to the user query embedding vector may be set according to the accuracy of the result.

The re-rank module 440 may calculate a final score for each item of the embedding vector list as illustrated in Equation 1. Each item in the embedding vector list may represent the similarity to the contents metadata, and the final score may represent the final similarity to the content.

$$final score = max ( {s}_{1} , {s}_{2} , … , {s}_{M} ) + w \times {\sum }_{i = 1}^{M} ( \frac{N - {r}_{i}}{N} ) \times {s}_{i} \qquad [ Equation 1 ]$$

In Equation 1, ri represents the rank of item i of the embedding vector list, si represents the score of item i, N represents the total number of embedding vector lists, and w represents the weight. Further,

$$\frac{N - {r}_{i}}{N}$$

represents the rank-based coefficient (RBFi) of item i, and the product

$$( \frac{N - {r}_{i}}{N} ) \times {s}_{i}$$

of the rank-based coefficient and the score of each item is referred to as the normalized score (ONSi). The value obtained by summing the normalized scores for each content becomes an accumulated normalized score. When calculating the accumulated normalized score, if the input value is a user query of two words or less, it is processed as an exception value (exception_NorScore) to process similarly to a keyword search and summed based on a higher threshold (e.g., 0.75). For example, an accumulated normalized score for the exception input value may be calculated as shown in Equation 2 below.

$$exception\_NorScore = {\sum }_{i = 1 , {s}_{i} > 0.75}^{M} ( \frac{N - {r}_{i}}{N} ) \times {s}_{i} \qquad [ Equation 2 ]$$

The accumulated normalized score

$${\sum }_{i = 1}^{M} ( \frac{N - {r}_{i}}{N} ) \times {s}_{i}$$

is multiplied by the weight value w, and the value obtained by adding the maximum similarity value max(s₁, s₂, . . . , s_{M}) thereto becomes the final score. The re-rank module 440 may re-rank them based on the final score.

After rearranging the embedding vectors, the re-rank module 440 may output a content list where duplicates for the content have been removed through the display 450. Alternatively, the re-rank module 440 may output the same as it is without removing the duplicates for the content corresponding to the rearranged embedding vectors, through the display 450.

The display 450 may display, on the search result screen, the search result content list and metadata of the corresponding content together with a message displaying the search result for the user query 401.

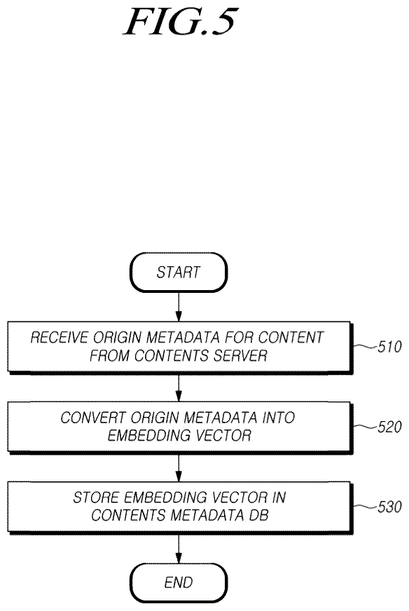

FIG. 5 is a flowchart illustrating an operation by which an electronic device stores metadata of content in a database according to an embodiment of the disclosure.

According to an embodiment, the electronic device (e.g., the electronic device 101 of FIG. 1 and the electronic device 201 of FIG. 2) may store origin metadata for content provided by the contents server in the contents metadata DB. In the following embodiment, each operation may be sequentially performed, but is not necessarily performed sequentially. For example, the order of the operations may be changed, and at least two operations may be performed in parallel.

In operation 510, according to an embodiment, the electronic device 101 may receive origin metadata for content from the contents server. The contents server may be generated and managed by one or more content providers that produce and/or distribute content. The contents server may store content data and information about the content as metadata. Metadata provided by the contents server may be referred to as origin metadata. The origin metadata may include origin information about the content. The origin information may include, e.g., a title, a character, an actor, a writer, a director, a release date (opening date), a genre, a synopsis, and a main plot. The electronic device 101 may receive the origin metadata for content from one or more contents servers.

In operation 520, according to an embodiment, the electronic device 101 may convert the origin metadata into an embedding vector. The electronic device 101 may embed the origin metadata using a text encoder. There may be one or more pieces of origin metadata.

In operation 530, according to an embodiment, the electronic device 101 may store the embedding vector in the contents metadata DB. In an embodiment, the contents metadata DB may be stored in the memory (e.g., the memory 220 of FIG. 2) of the electronic device 101. Alternatively, in an embodiment, the contents metadata DB may be implemented as a separate storage device, server, or cloud server.

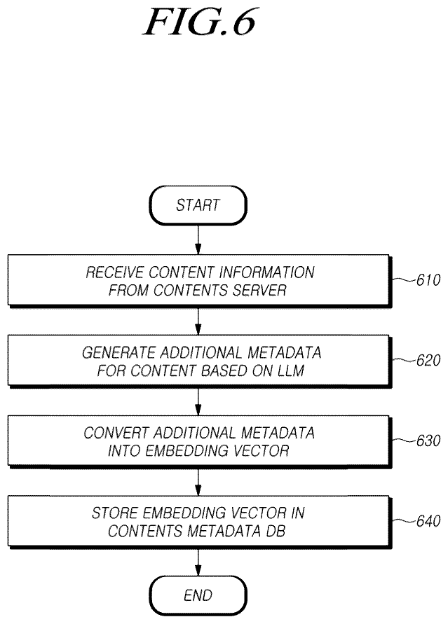

FIG. 6 is a flowchart illustrating an operation by which an electronic device stores additional metadata of content in a database according to an embodiment of the disclosure.

According to an embodiment, the electronic device (e.g., the electronic device 101 of FIG. 1 and the electronic device 201 of FIG. 2) may store additional information obtained for the content as metadata. In the following embodiment, each operation may be sequentially performed, but is not necessarily performed sequentially. For example, the order of the operations may be changed, and at least two operations may be performed in parallel.

In operation 610, according to an embodiment, the electronic device 101 may receive content information from the contents server. The content information may be one or more pieces of information capable of identifying the content. The content information may be origin information stored by the content producer. For example, the content information may include at least some of the title, character, actor, writer, director, release date, genre, synopsis, and main plot.

In operation 620, according to an embodiment, the electronic device 101 may generate additional metadata for content based on a large language model (LLM). The electronic device 101 may generate a prompt requesting additional information about the content and obtain additional information describing the content by inputting the prompt into the LLM.

Table 1 is an example of the prompt requesting additional information about content.

TABLE 1

```
      <task> You have to generate additional metadata for given movie/show </task>
      <goal> Main Goal for generating [contents title] extra metadata is to enable deep
and smart search for users. This data will be converted to vector embedding for KNN search
with user query which means we cannot have repetition of nouns/words in our generated
metadata.
      Each piece of information is required only once.
      As you know there could be multiple contents with same titles,
      So carefully understand the input information and If you donot know or understand
about the asked content, Pls give blank output.
      Do Not hallucinate. </goal>
      <requirements>
      Categories for which you need to generate content descriptors are
      - Time Period (displayed in story), Mood, Theme, Setting, Subject, Cultural
Background (American, English, Indian, African, British etc.),
      Story Classification [different to genres given in prompt], Film Industry (Bollywood,
Hollywood, Hollywood etc.).
      Best for which generation (Gen X, millennials, Gen Z, Gen alpha, adults, old-age,
young, children, teenagers [return 1 of these values in english]),
      Around Relationship (signifies relations between lead characters like father-
daughter, husband-wife, student-teacher etc.),
      Character Profession (of lead characters only), prominent keywords(most important
words regarding the program not considered in any other content descriptor),
      Plot1(clearly describes plot/story of program in minimum 350 words),
      Plot2(Explain important scenes with information like (story classification, overall
mood, themes covered, important topics covered, highlights shown).
      Do not directly give the words in response only information is required in minimum
300 words),
      plot3 (clearly explains what happened in the ending/climax of the program and other
key information like hidden meaning, hidden message in minimum 300 words).
      Related (Generate at least 10 related contents for a movie/show.
      Each related content must be specified only once, Related Content signifies other
contents with same genre, actor, director etc.
      that user can watch or we can recommend. For internal purpose, we would also need
release date in format YYYY-MM-DD and also its type (movie or show)).
      Also specify the casts and directors of the asked content
      </requirements>
      Also, these Plots are for semantic search so only give relevant information in a
contextual way only. Do not give redundant information or words. Give the response in
following [JSON] format [Must Generate values in English language] {
        “Content Descriptor”: {
          “Time Period”: “”,
          “Mood”: “”,
          “Theme”: “”,
          “Setting”: “”,
          “Subject”: “”,
          “Character Profession”: “”,
          “Prominent Keywords”: “”,
          “Cultural Background”: “”,
          “Story Classification”: “”,
          “Best for which generation”: “”,
          “Film Industry”: “”,
          “Around Relationship”: “”,
          “Hidden Meaning”: “”,
          “Hidden Message”: “”,
          “Plot1”: “”,
          “Plot2”: “”,
          “Plot3”: “”,
          “Release Year”:“”,
          “Cast”:“”,
          “Director“.“”,
          “Related”: [
            {
              “Title”: “”,
              “Released Year”: “”,
              “Type”:“”
            }
          ]
        }
    }
```

The prompt of Table 1 may be composed of a task definition for requesting to generate additional metadata, a specific goal definition for generating metadata, a requirements definition for describing categories necessary to generate the content describer and conditions for each category, and a data format (e.g., JSON) definition for the generated metadata. Categories are intended to obtain content information for each detailed item, and includes, e.g., in Table 1, time period, mood, theme, setting, subject, character profession, prominent keywords, cultural background, story classification, best for which generation, film industry, around relationship, hidden meaning, hidden message, plot, release year, cast, director, or related videos (related title, released year, type).

According to an embodiment, the electronic device 101 may generate various prompts. The prompt may vary according to the type of content.

According to an embodiment, the electronic device 101 may generate the additional information generated by the LLM as additional metadata for the content.

In operation 630, according to an embodiment, the electronic device 101 may convert additional metadata into an embedding vector using a text encoder. There may be one or more pieces of additional metadata, and there may also be one or more embedding vectors.

In operation 640, according to an embodiment, the electronic device 101 may store the embedding vector in the contents metadata DB. In an embodiment, the contents metadata DB may be stored in the memory (e.g., the memory 220 of FIG. 2) of the electronic device 101. Alternatively, in an embodiment, the contents metadata DB may be implemented as a separate storage device, server, or cloud server.

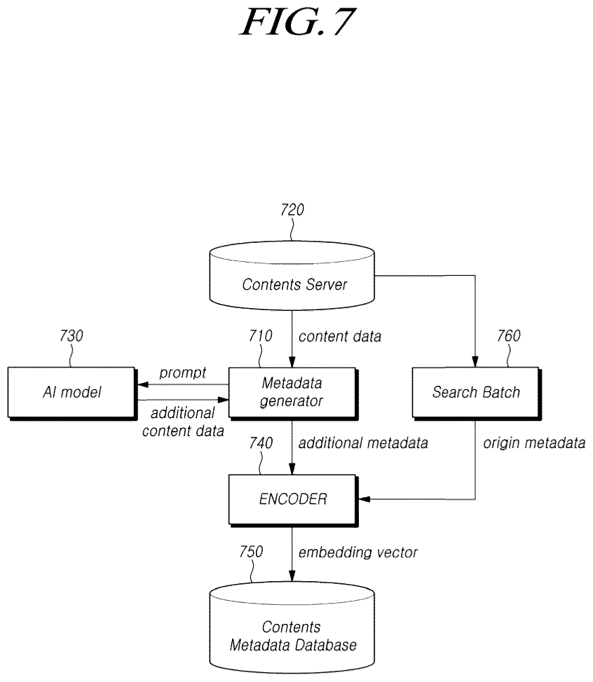

FIG. 7 is a block diagram illustrating a metadata generation function component of an electronic device according to an embodiment of the disclosure.

According to an embodiment, the electronic device (e.g., the electronic device 101 of FIG. 1 and the electronic device 201 of FIG. 2) may receive content information from the content providing server, generate metadata for the content, and store and manage it in a contents metadata database. The electronic device 101 may include a metadata generator 710, a contents server 720, an artificial intelligence model 730, an encoder 740, a contents metadata database 750, and a search batch 760, as components related to a metadata generation function. According to an example, the electronic device 101 may include additional components (e.g., a communication circuit) other than the illustrated components, or may omit at least one of the illustrated components. The omitted component may be provided by an external electronic device (e.g., a cloud server), and the electronic device 101 may transmit/receive necessary data through data communication with the external electronic device.

The metadata generator 710 may receive content data from the contents server 720 and obtain additional information about the content to generate additional metadata. The content data may include one or more pieces of information capable of identifying content provided by the contents server 720. For example, it may include the title, cast, writer, or director information about the content. The metadata generator 710 may obtain additional information about the content using the AI model 760. The metadata generator 710 may transmit a prompt requesting generation of additional information about the content to the AI model 760 and receive additional content data generated by the AI model 760.

The AI model 760 may generate additional information about the content. For example, the AI model 760 may be a large language model that receives a request in the form of a prompt and generates an answer according to the request. LLM refers to an artificial neural network-based language model that has learned a large amount of text data through prior learning. LLM may include far more parameters (e.g., more than 10 billion) than conventional general language models. LLM may use a transformer artificial neural network structure based on an attention mechanism.

The attention mechanism is a technology that helps the artificial intelligence model focus on important portions within input data. The attention mechanism may be used for output data prediction by predicting the degree to which at least a part of the time series input data (e.g., the input data such as voice and video or input data of some layers of the neural network) contributes to the intermediate or final output of the neural network. The recurrent neural network (RNN) structure, which sequentially processes each element of a sequence, has poor prediction performance when there is information dependency between long time series distances, but the attention mechanism may consider information dependency between long time series distances by controlling the degree of weight attention within the context of the entire or part of the input data.

The transformer may be configured in an encoder-decoder structure. The encoder may process input data to output compressed information (e.g., contextual representation), and the decoder may process the compressed information to output the output data in token units. Each of the encoder and decoder may include an independent attention network and may include a cross-attention network connecting the encoder and the decoder.

For example, LLM training may include pre-training and/or fine-tuning. Pre-training is a process that allows the LLM to obtain general language knowledge using a large amount of text data, and may include self-supervised learning, e.g., predicting the next word using the previous word string of the text string. Fine tuning is a process of training the LLM to suit specific domains (e.g., chatbot, translation, summary, Q&A), and the LLM may be additionally supervised trained (or adaptively trained) with datasets tailored to domain purposes based on pre-trained models. LLM may perform tasks with text input including natural language called prompts.

For example, fine tuning may be omitted when training the LLM. The user may control the prompts to be input to the LLM to enhance the performance of the desired task. A guide for performing a task and/or an example of a task may further be provided to the prompt in a manner like in-context learning or zero-shot/few-shot learning. Known LLMs include bidirectional encoder representations from transformer (BERT), generative pre-trained transformer (GPT), etc.

The AI model 760 may additionally receive image (including video) information in addition to text. The image information may be converted into text through a separate pre-conversion (e.g., image recognition, scene recognition) and included in the prompt to generate a response. As another example, the input image may be converted into an image embedding aligned with the text through an image encoder, and a response may be generated with a model (e.g., a large multimodal model) separately trained with the text embedding corresponding to the input text.

The term “LLM” may refer to the language neural network model itself, but may also refer to a model of an LLM-based application (e.g., chatbot, translation, summary, text classification, sentence generation). For example, an LLM-based chatbot or LLM-based translator may also be referred to as an ‘LLM’.

The ‘LLM’ may include an inference engine using an LLM neural network model. For example, “inputting the input prompt into the LLM” may mean “inputting the input prompt into the LLM-based inference engine.” For example, “the output of LLM in response to the input prompt” may refer to the output information (or output information modified through additional processing) from the LLM last neural network layer obtained when the input prompt is input into the LLM-based inference engine.

The metadata generator 710 may store additional content data generated by the AI model 760 as metadata, embed the same, and store it in the contents metadata database 750. The metadata generator 710 may transfer additional metadata to the encoder 740, and the encoder 740 may convert the additional metadata into an embedding vector and store the same in the contents metadata database 750.

The search batch 760 may receive origin information about the content from the contents server 720 and store it, as origin metadata, in the contents metadata database 750. The search batch 760 may transfer the origin metadata to the encoder 740, and the encoder 740 may convert the origin metadata into an embedding vector and store it in the contents metadata database 750.

The contents metadata database 750 may store and manage one or more pieces of metadata for the content in the form of an embedding vector.

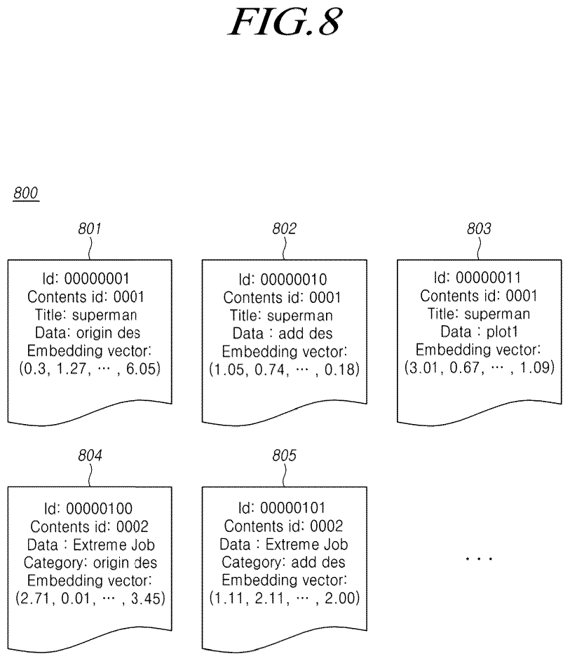

FIG. 8 illustrates an example of metadata according to an embodiment of the disclosure.

According to an embodiment, the contents metadata database 800 (e.g., the contents metadata database 420 of FIG. 4 and the contents metadata database 750 of FIG. 7) may include a plurality of pieces of metadata. Each of the pieces of metadata 801, 802, 803, 804, and 805 may include identification information id, content id, content title, data classification, and embedding vector.

The first metadata 801, the second metadata 802, and the third metadata 803 relate to first content (content id: 0001). The fourth metadata 804 and the fifth metadata 805 relate to second content (content id, 0002). Metadata for the same content may be classified by the data classification. The contents metadata database 800 may be determined to include a limited number of pieces of metadata for each data classification according to the data management policy. For example, if the data classification is a plot, up to three pieces of metadata may be stored for the plot. In an embodiment, the data management policy may be different for each contents metadata database 800, and data classification may be defined differently.

The embedding vector of metadata may be defined as a value embedded in K dimensions. The number of dimensions may be determined by the text encoder. The dimension of the embedding vector of the metadata and the dimension of the embedding vector embedding the user utterance may be the same.

According to an embodiment, the electronic device (e.g., the electronic device 101 of FIG. 1 and the electronic device 201 of FIG. 2) may receive the user utterance and, in the case of a sentence-like search request, extract one or more contents related to the user utterance from among metadata included in the contents metadata database 800 as a search result. The electronic device 101 may calculate a similarity between the embedding vector embedding the user utterance and the embedding vector value of the metadata, and extract metadata having a similarity larger than or equal to a threshold as a search result. Since the contents metadata database 800 includes the embedding vector value of each piece of metadata, the similarity calculation with the embedding vector value embedding the user utterance may be performed quickly.

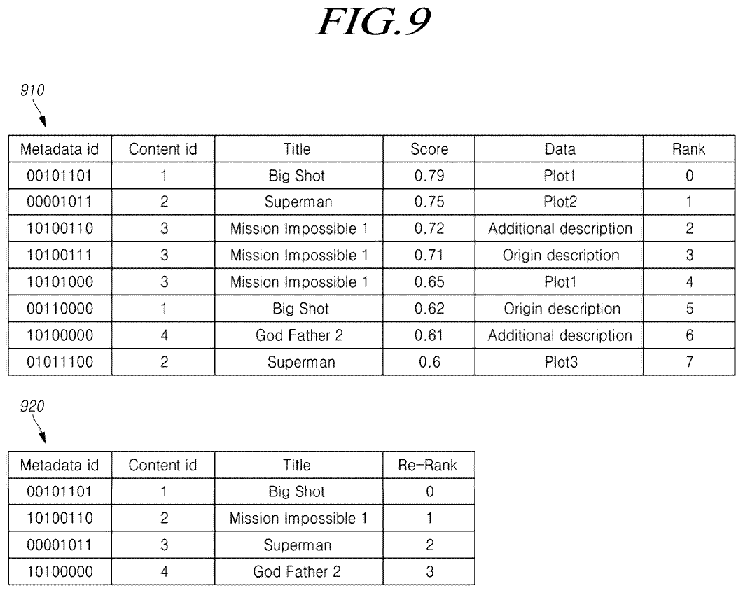

FIG. 9 illustrates an example of a search result table according to a user utterance of an electronic device according to an embodiment of the disclosure.

According to an embodiment, the electronic device (e.g., the electronic device 101 of FIG. 1 and the electronic device 201 of FIG. 2) may search the contents metadata database (e.g., the contents metadata database 420 of FIG. 4 and the contents metadata database 750 of FIG. 7) for content that is highly related to the user utterance, and provide the search result to the user. The contents metadata database 410 may store information about content for each piece of metadata. The electronic device 101 may output a search result metadata list according to the similarity search between the contents metadata and the user utterance as illustrated in Table 1 910 of FIG. 9.

In Table 1 910, the search result metadata list may be sorted and displayed in the descending order of the similarity values (score). The electronic device 101 or the re-rank module (the re-rank module 440 of FIG. 4) of the electronic device 101 may re-rank the list according to the content considering the similarity and the weight for the same content in the search result metadata list. Table 2 920 represents a list rearranged according to the content considering similarity and weight for the same content in the contents metadata search result. Table 1 910 represents some of the total search results, and Table 2 920 represents a realignment list of the search results of Table 1 910.

Referring to FIG. 9, when the total number N of items included in the metadata list is 200 and the rank index according to the score is 0 to 199, Table 1 910 represents ranks 0 to 7 according to the similarity value. Table 2 920 illustrates a list where Table 1 910 is rearranged for each content.

In Table 1 910, the title of the 0th-ranked content (metadata id=00101101) is big shot, and there is one same content (content id=1) which is the 5th-ranked content (metadata id=00110000). The title of the 1st-ranked content (metadata id=00001011) is superman, and there is one same content (content id=2) which is the seventh priority content (metadata id=01011100). The title of the 2nd-ranked content (metadata id=10100110) is mission impossible 1, and there are three same contents (content id=3) which are the 2nd-ranked, 3rd-ranked, and 4th-ranked contents.

The re-rank module 440 may calculate a final score for the contents of Table 1 910 according to Equation 1. For example, the following Table 2 represents a score calculation formula according to Equation 1.

TABLE 2

| Con- | | |
|---|---|---|
| tent | | |
| id | title | Final score |
| 1 | Big Shot | 0.79 + 0.1* (0.79*(200-0)/200 + 0.62*(200-5)/200) |
| 2 | Superman | 0.75 + 0.1*(0.75* (200-1)/200 + 0.6 *(200-7)/200) |
| 3 | Mission | 0.72 + 0.1* (0.72*(200-2)/200 + 0.71*(200-3)/ |
| | Impossible1 | 200 + 0.65*(200-4)/200) |
| 4 | God Father2 | 0.61 + 0.1*(0.61*(200-6)/200) |

The result rearranged according to the final score calculated as shown in Table 2 are shown in Table 2. Unlike Table 1 910, in Table 2 920, the 1st-ranked content is mission impossible1, not superman. It reflects that the metadata for mission impossible 1 was searched three times, and superman was searched two times.

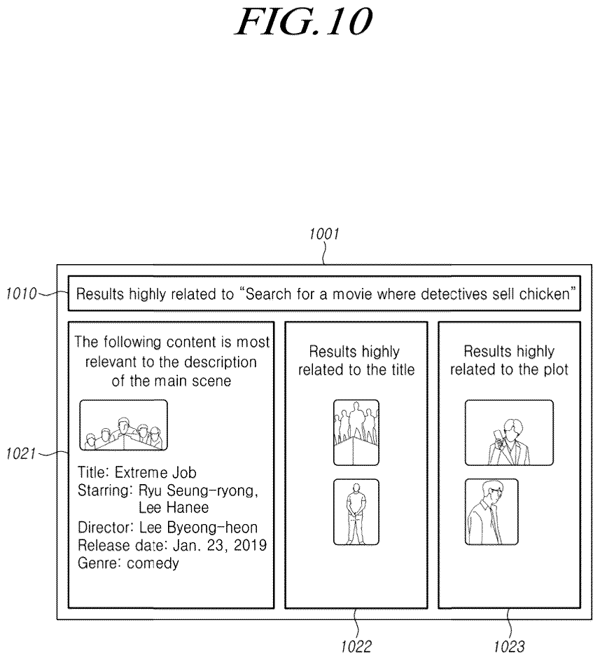

FIG. 10 illustrates an example of a search result screen of an electronic device according to an embodiment of the disclosure.

According to an embodiment, the electronic device (e.g., the electronic device 101 of FIG. 1 and the electronic device 201 of FIG. 2) may output a search result screen for the user utterance through the display 1001 (e.g., the display 110 of FIG. 1 and the display 230 of FIG. 2).

According to an embodiment, the electronic device 101 may display a first portion 1010 displaying a search result for a search query including the user utterance, a second portion 1021 displaying the content having the highest similarity to the user utterance as a search result, and a third portion 1022 and a fourth portion 1023 displaying the content of the search result according to the type of metadata on the screen of the display 1001.

The first portion 1010 may directly display a text portion (“Search for a movie where detectives sell chicken”) obtained by voice-recognizing the user utterance, and may display “a result highly related to the user utterance” to indicate the display of the result with the high correlation.

The second portion 1021 may display the content having the highest search rank according to the result rearranged by determining similarity and reflecting the weight for the same content. The second portion 1021 may display the type of metadata (e.g., main scene) determined to have a high similarity, and may display origin information about the content together.

The third portion 1022 and the fourth portion 1023 may display content with the next highest search rank according to similarity determination and rearrangement, displaying a case 1022 in which the type of metadata is a title 1022 and a case 1023 in which the type of metadata is a plot, respectively, and may specify the type of metadata.

The electronic device 101 according to an embodiment may provide a description of the search result process to the user by displaying the type of metadata (e.g., main scene, title, and plot) for the search result together.

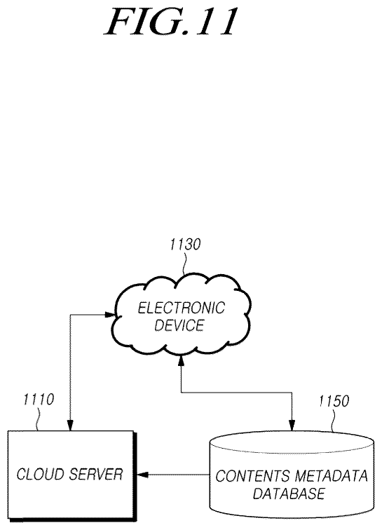

FIG. 11 illustrates an electronic device, a database, and a cloud server according to an embodiment of the disclosure.

According to an embodiment, the electronic device 1110 may interact with the cloud server 1030 and the contents metadata database 1050 to provide a content search according to the user utterance.

The contents metadata database 1050 may store metadata for content in the form of an embedding vector, and may be included in the memory of the electronic device (e.g., the memory 220 of FIG. 2) or may be implemented as a separate storage device 1050. When the contents metadata database 1050 is included in a separate storage device as illustrated in FIG. 11, the electronic device 1110 may access the contents metadata of the contents metadata database 1050 through a communication circuit (e.g., the communication circuit 270 of FIG. 2).

The processor (e.g., the processor 210 of FIG. 2) of the electronic device 1110 may determine the similarity between the user utterance and the metadata. Alternatively, at least a partial operation of the rearrangement operation considering the similarity determination and the weight for the same content may be performed through the cloud server 1130 that provides semantic-based content search. The electronic device 1110 may transmit/receive data to/from the cloud server 1030 through the communication circuit 270. The cloud server 1130 may be connected to the electronic device 1110 and the contents metadata database 1150 based on wireless communication.

A server 1130 according to an embodiment may comprise a communication circuit, a memory, and at least one processor. The at least one processor may, when receiving a user voice input for a content search request from a first electronic device through the communication circuit, obtain similarities between a plurality of metadata embedding vectors included in a metadata database and a first query embedding obtained based on the user voice input, obtain one or more similar pieces of metadata corresponding to a similarity of a first threshold or more among the plurality of metadata embedding vectors, and transmit, through the communication circuit to the first electronic device, information related to contents corresponding to the one or more similar pieces of metadata, including order information based on at least one of the similarity or a weight for other metadata of the same content.

According to an embodiment, the at least one processor may receive information corresponding to first content from an external server through the communication circuit, and store an embedding vector obtained based on the information corresponding to the first content, as metadata for the first content, in the metadata database.

According to an embodiment, the information corresponding to the first content may include at least one of a title, a character, an actor, a writer, a director, a synopsis, a release date, a genre, or a main plot.

According to an embodiment, the at least one processor may obtain additional information corresponding to the first content using an artificial intelligence model, and obtain an embedding vector obtained based on the additional information as the metadata corresponding to the first content and stores the embedding vector in the metadata database.

According to an embodiment, the at least one processor may generate a prompt corresponding to obtaining one or more pieces of category information corresponding to the first content, and obtain information obtained through the artificial intelligence model based on the prompt as the additional information for the first content.

According to an embodiment, the additional information may include at least one of a time period, an mood, a theme, a setting, a subject, a character profession, a prominent keyword, a cultural background, a story classification, best for which generation, a film industry, an around relationship, a hidden meaning, a hidden message, a plot, a year of publication, a cast, a director, or a related video.

According to an embodiment, the at least one processor may obtain the similarities between the plurality of metadata embedding vectors included in the metadata database and the first query embedding through a cosine similarity calculation method.

According to an embodiment, the at least one processor may assign a weight to each of similarity values of pieces of metadata corresponding to the same content for the one or more pieces of similar metadata, obtain a final similarity for each content for the one or more pieces of similar metadata, and rearrange the one or more pieces of similar metadata according to the obtained final similarity.

According to an embodiment, the at least one processor may, when metadata having the similarity of the first threshold or more among the plurality of metadata embedding vectors is not obtained, store the user voice input in a voice input database, and transmit information corresponding to a search failure to the first electronic device through the communication circuit.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display;
a microphone; and
at least one processor configured to:
receive a user voice input through the microphone,
obtain a first query embedding based on the user voice input,
obtain similarities between a plurality of metadata embedding vectors included in a metadata database and the first query embedding,
obtain, among the plurality of metadata embedding vectors, one or more similar pieces of metadata having a similarity greater than or equal to a first threshold value based on the similarities,
obtain an order of the one or more similar pieces of metadata based on the similarity or a weight for at least one metadata belong to a same content, and
control the display to output, according to the order, information related to contents corresponding to the one or more similar pieces of metadata.

2. The electronic device of claim 1, wherein the at least one processor is configured to:
receive information corresponding to a first content from a server, and
obtain the plurality of metadata embedding vectors, based on the information corresponding to the first content, for the first content.

3. The electronic device of claim 2, wherein the information corresponding to the first content includes at least one of a title, a character, an actor, a writer, a director, a synopsis, a release date, a genre, or a main plot.

4. The electronic device of claim 2, wherein the at least one processor is configured to:
obtain additional information corresponding to the first content using an artificial intelligence model, and
obtain the plurality of metadata embedding vectors, based on the additional information corresponding to the first content, for the first content.

5. The electronic device of claim 4, wherein the at least one processor is configured to:
generate a prompt corresponding to obtaining one or more pieces of category information corresponding to the first content, and
obtain information through the artificial intelligence model, based on the prompt, as the additional information corresponding to the first content.

6. The electronic device of claim 4, wherein the additional information includes at least one of a time period, a mood, a theme, a setting, a subject, a character profession, a prominent keyword, a cultural background, a story classification, a best for which generation, a film industry, an around relationship, a hidden meaning, a hidden message, a plot, a year of publication, a cast, a director, or a related video.

7. The electronic device of claim 1, wherein the at least one processor is configured to obtain the similarities between the plurality of metadata embedding vectors included in the metadata database and the first query embedding through a cosine similarity calculation method.

8. The electronic device of claim 7, wherein the at least one processor is configured to:
assign weights to each of the similarities of pieces of metadata belong to the same content among the one or more pieces of similar metadata,
obtain a final similarity for each content for the one or more similar pieces of metadata; and
rearrange, according to the final similarity, the one or more similar pieces of metadata.

9. The electronic device of claim 1, wherein the at least one processor is configured to:
control the display to output information related to the contents corresponding to the one or more similar pieces of metadata, including a description corresponding to a category of the metadata.

10. The electronic device of claim 1, wherein the at least one processor is configured to:
based on the one or more similar pieces of metadata corresponding to a similarity less than the threshold,
store the user voice input in a voice input database, and
control the display to output information corresponding to a search failure.

11. A server comprising:
a communication circuit;
memory; and
at least one processor configured to:
receive a user voice input for a content search request from a first electronic device through the communication circuit,
obtain a first query embedding based on the user voice input,
obtain similarities between a plurality of metadata embedding vectors included in a metadata database and the first query embedding,
obtain, among the plurality of metadata embedding vectors, one or more similar pieces of metadata having a similarity greater than or equal to a first threshold value based on the similarities,
obtain an order of the one or more similar pieces of metadata based on the similarity or a weight for at least one metadata belong to a same content, and
transmit, through the communication circuit to the first electronic device, information related to contents corresponding to the one or more similar pieces of metadata, including the order.

12. The server of claim 11, wherein the at least one processor is configured to:
receive information corresponding to a first content from an external server through the communication circuit, and
store the plurality of metadata embedding vectors, based on the information corresponding to the first content, for the first content, in the metadata database.

13. The server of claim 12, wherein the information corresponding to the first content includes at least one of a title, a character, an actor, a writer, a director, a synopsis, a release date, a genre, or a main plot.

14. The server of claim 12, wherein the at least one processor is configured to:
obtain additional information corresponding to the first content using an artificial intelligence model,
obtain the plurality of metadata embedding vectors, based on the additional information corresponding to the first content, for the first content, and
store the plurality of metadata embedding vectors in the metadata database.

15. The server of claim 14, wherein the at least one processor is configured to:
generate a prompt corresponding to obtaining one or more pieces of category information corresponding to the first content, and
obtain, through the artificial intelligence model, information based on the prompt as the additional information corresponding to the first content.

16. The server of claim 14, wherein the additional information includes at least one of a time period, a mood, a theme, a setting, a subject, a character profession, a prominent keyword, a cultural background, a story classification, a best for which generation, a film industry, an around relationship, a hidden meaning, a hidden message, a plot, a year of publication, a cast, a director, or a related video.

17. The server of claim 11, wherein the at least one processor is configured to obtain the similarities between the plurality of metadata embedding vectors included in the metadata database and the first query embedding through a cosine similarity calculation method.

18. The server of claim 17, wherein the at least one processor is configured to:
obtain similarity values for each similarity between the plurality of metadata embedding vectors included in the metadata database and the first query embedding,
assign weights to each of the similarities of pieces of metadata belong to the same content among the one or more pieces of similar metadata,
obtain a final similarity for each content for the one or more similar pieces of metadata, and
rearrange, according to the final similarity, the one or more similar pieces of metadata.

19. The server of claim 11, wherein the at least one processor is configured to:
based on the one or more similar pieces of metadata corresponding to a similarity less than the threshold,
store the user voice input in a voice input database, and
transmits information corresponding to a search failure to the first electronic device through the communication circuit.

20. A non-transitory, computer-readable storage medium storing instructions, wherein the instructions, when executed by one or more processors, enable the one or more processors to:
receive a user voice input through a microphone of an electronic device,
obtain a first query embedding based on the user voice input,
obtain similarities between a plurality of metadata embedding vectors included in a metadata database and the first query embedding,
obtain, among the plurality of metadata embedding vectors, one or more similar pieces of metadata having a similarity greater than or equal to a first threshold value based on the similarities,
obtain an order of the one or more similar pieces of metadata based on the similarity or a weight for at least one metadata belong to a same content, and
control a display of the electronic device to output, according to the order, information related to contents corresponding to the one or more similar pieces of metadata.
